(19) United States
(12) Patent Application Publication
(10) Pub. No.: US 2026/0090527 A1
(43) Pub. Date: Apr. 2, 2026

(54) AQUARIUM WATER FILTRATION DEVICE

(71) Applicant: Anni MAO, Shenzhen (CN)

(72) Inventor: Anni MAO, Shenzhen (CN)

(21) Appl. No.: 19/244,466

(22) Filed: Jun. 20, 2025

(30) Foreign Application Priority Data
Sep. 27, 2024 (CN) 2024223660984

(51) Int. Cl. A01K 63/04

(52) U.S. Cl. CPC A01K 63/045

(57) ABSTRACT

Disclosed is an aquarium water filtration device, which comprises a suction assembly configured to draw wastewater from an aquarium, a filter assembly configured to filter the wastewater, and a pump configured to drive a water flow. A control valve includes a first inlet port in fluid communication with the pump, a first outlet port, and a second outlet port. A backwater channel connects the second outlet port to the aquarium to guide filtered water back. A drainage channel connects the first outlet port to discharge wastewater. The control valve is configured to selectively switch the water flow path between the first outlet port and the second outlet port. This allows a user to selectively direct the water to the backwater channel for normal filtration and circulation or to the drainage channel for discharging wastewater during maintenance or water changes.

### CROSS-REFERENCE TO RELATED APPLICATIONS

This application claims priority to Chinese Patent Application No. 2024223660984, filed Sep. 27, 2024, which is entirely incorporated herein by reference.

### TECHNICAL FIELD

This application relates to aquarium maintenance devices, and specifically relates to an aquarium water filtration device.

### BACKGROUND

Maintaining clean and stable water quality within an aquarium requires routine upkeep. This typically involves removing accumulated bottom debris, filtering waterborne impurities, and performing partial or complete water changes. However, conventional manual techniques for water exchange and debris suction are often inefficient and labor-intensive, frequently leading to undue disturbance of aquarium inhabitants. Moreover, existing aquarium cleaning devices on the market generally offer limited functionality, providing only a single operation such as debris suction or water filtration. Consequently, these devices fail to adequately address a user's need to perform multiple maintenance operations concurrently. Accordingly, there remains an unmet need for an integrated aquarium water filtration device that combines debris suction, water filtration, and water exchange capabilities into a single, convenient, and highly efficient apparatus.

### SUMMARY

This Summary is provided to introduce a selection of concepts in a simplified form that are further described below in the Detailed Description. This Summary is not intended to identify key aspects or essential aspects of the claimed subject matter. Moreover, this Summary is not intended to limit the scope of the claimed subject matter.

An aquarium water filtration device is provided, comprising:
a suction assembly configured to draw wastewater from an aquarium;
a filter assembly, in fluid communication with the suction assembly, is configured to filter the wastewater;
a pump, in fluid communication with the filter assembly, is configured to drive a water flow;
a control valve having a first inlet port, a first outlet port, and a second outlet port, wherein the first inlet port is in fluid communication with the pump;
a backwater channel, in fluid communication with the second outlet port, is configured to guide filtered water back to the aquarium; and
a drainage channel, in fluid communication with the first outlet port, is configured to discharge the wastewater out of the aquarium;
wherein the control valve is configured to selectively switch the flow state of the first outlet port and the flow state of the second outlet port to selectively guide the water to the backwater channel or the drainage channel.

The above aspects or examples and advantages, as well as other aspects or examples and advantages, will become apparent from the ensuing description and accompanying drawings.

### BRIEF DESCRIPTION OF DRAWINGS

To illustrate the technical solutions according to the embodiments of the present disclosure or in the prior art more clearly, the accompanying drawings for describing the embodiments or the prior art are introduced briefly in the following. Apparently, the accompanying drawings in the following description are only some embodiments of the present disclosure, and persons of ordinary skill in the art can derive other drawings from the accompanying drawings without creative efforts.

FIG. 1 is an overall schematic view of an aquarium water filtration device according to an embodiment of the present application;

FIG. 2 is an exploded schematic view of the aquarium water filtration device shown in FIG. 1;

FIG. 3 is an overall schematic view of a second suction port according to an embodiment of the present application;

FIG. 4 is an internal schematic view of control valve and seal cap assembly within the handle shown in FIG. 2; and,

FIG. 5 is an internal schematic view of the backwater channel within the handle shown in FIG. 2.

### REFERENCE NUMBERS

first suction port—1; first inlet pipe—2; adapter—3; second inlet pipe—4; filter housing cover—5; filter housing—6; first connecting pipe—7; pump—8; wire—9; drain end—10; handle—11; button—12; seal cap—13; control valve—14; knob—15; second connecting pipe—16; third connecting pipe—17; drain hole—18; chamber—19; second suction port—20; first outlet port—21; first inlet port—22; outlet channel—23; filter-mounting structure—24.

### DETAILED DESCRIPTION OF THE EMBODIMENTS

The present disclosure will be further described in detail below with reference to the drawings. A preferred embodiment is described in the drawings. However, the present disclosure can be implemented in many different forms and is not limited to the embodiments described herein. Rather, these embodiments are provided to provide a thorough understanding of the present disclosure. The specific embodiments are only explanations of the present disclosure, and the embodiments are not intended to limit the present disclosure. Rather, various modifications may be made in the details within the scope and range of equivalents of the claims and without departing from the present disclosure.

The present disclosure will be described in more details below with reference to the accompanying drawings and in conjunction with embodiments. The examples are provided for better illustration of the present disclosure and should not limit the scope of the present disclosure. In practice, technicians skilled in the art might make small modifications and/or variations of the present disclosure without departing from the scope or spirit of the present disclosure. For example, features described in part of one embodiment may be used in another to create a new embodiment. It is therefore desirable that the present disclosure encompass such modifications and/or variations falling within the scope of the appended claims and their equivalents.

In the description of the present disclosure, terms like “longitudinal”, “transverse”, “up”, “down”, “front”, “back”, “left”, “right”, “vertical”, “horizontal”, “top”, “bottom” denote orientation or positional relationships based on those shown in the drawings and are intended for ease of description only, which in no way entails that the present disclosure must be constructed and operated in a particular orientation and therefore cannot be construed as limiting to the present disclosure. Terms like “joint”, “attach” and “set” used in the present disclosure should be understood in a broad sense, for example, may indicate a direct connection or indirect connection through intermediate components; and it may be a wired electrical connection, a radio connection, or a wireless communication signal connection. The exact meanings of the above terms may slightly differ and should be derived from the actual situation by technicians skilled in the art accordingly.

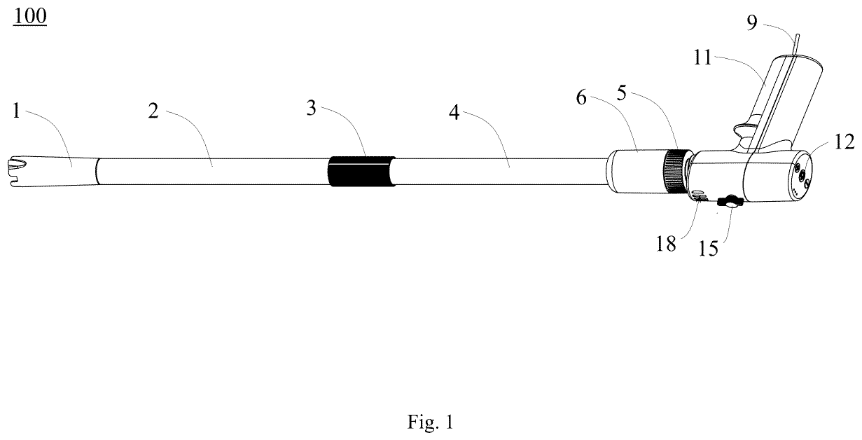

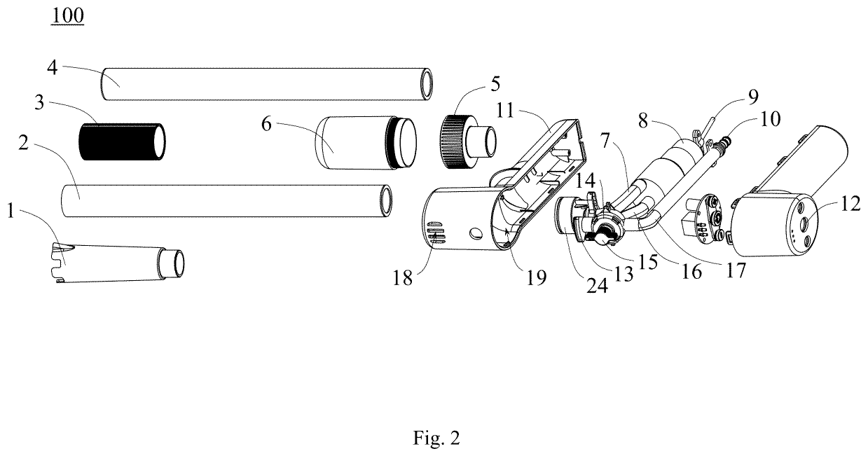

Referring to FIGS. 1-2, in this exemplary embodiment, the aquarium water filtration device 100 primarily includes a suction assembly, a filter assembly, a pump 8, a control valve 14, a backwater channel, a drainage channel, and a handle 11.

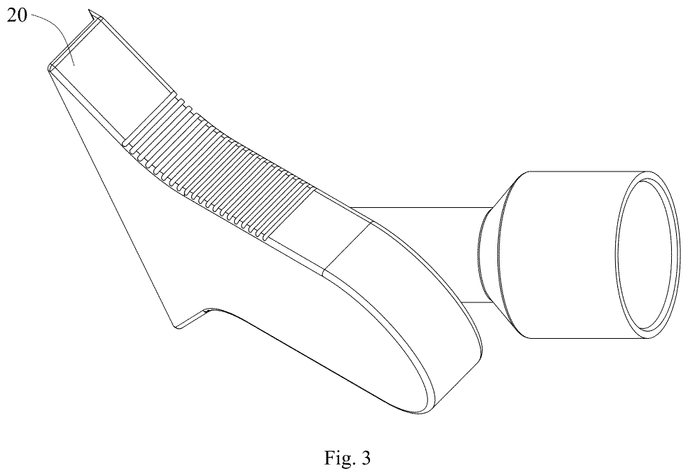

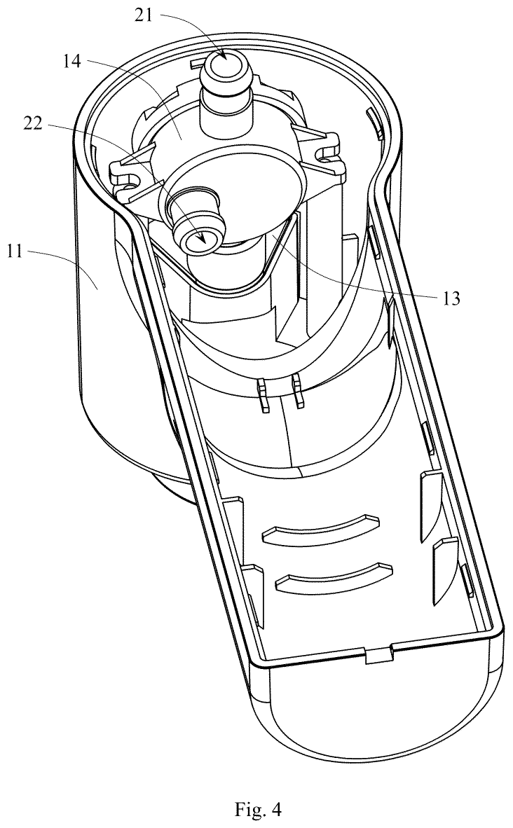

The suction assembly is configured to draw wastewater containing debris from an aquarium. As shown in FIGS. 1 and 2, this assembly includes a first suction port 1 and a first inlet pipe 2. The first suction port 1 is designed with a shape suitable for drawing debris near the substrate, such as the serrated edge shown in FIG. 1, which facilitates stirring and drawing in debris from crevices in the substrate, making it suitable for precise, localized, or small-area cleaning. The first inlet pipe 2 is straight, its upstream end (the end closer to the suction port) is detachably connected to the first suction port 1, and its downstream end is connected to the filter assembly, for example, directly connected to the filter housing 6 or connected to the filter housing 6 via a subsequent extension pipe. In some embodiments, to accommodate aquariums of different depths or varying operational requirements, the suction assembly may further include an adapter 3 and a second inlet pipe 4. The first inlet pipe 2 and the second inlet pipe 4 can be connected via adapter 3 to form a longer suction path. This modular design allows users to adjust the overall length of the suction assembly flexibly by combining the first inlet pipe (2), the adapter 3, and the second inlet pipe 4. In some embodiments, as shown in FIG. 3, the present application also provides an alternative second suction port 20, which is replaceable with the first suction port 1. The second suction port 20 is also designed to be detachably connected to the upstream end of the first inlet pipe 2. Compared to the first suction port 1, the second suction port 20 has a wider opening and a different contour design. For example, the second suction port 20 features a flatter or angled suction surface, making it more suitable for the rapid cleaning of large, flat-bottomed areas of the aquarium (e.g., bare tank bottoms or extensive areas of fine-sand substrate). This structure enables it to cover a wider cleaning path simultaneously, thereby improving the efficiency of large-scale cleaning. Its top textured structure (as shown in FIG. 4) facilitates sliding on the substrate or guiding water flow. Users can select to install either the first suction port 1 or the second suction port 20 based on specific cleaning tasks, such as precise cleaning of corners and crevices or rapid, large-area substrate cleaning.

The filter assembly is in fluid communication with the suction assembly. It is configured to physically intercept and remove solid impurities contained in the wastewater drawn from the suction assembly, such as fish food residue, excrement, and substrate debris, thereby purifying the water. The filtered water then flows downstream to the pump and subsequent channels while also protecting precision components, such as the pump impeller, from damage by larger particulates. This assembly is designed to be maintainable, allowing a user to conveniently clean or replace the filter medium. As shown in FIGS. 1 and 2, the assembly primarily includes a filter housing 6, a detachable filter housing cover 5, and a filter installation structure 24 for installing a filter medium (not shown, typically a porous filter material). A filter medium can be selectively installed within the filter housing 6, and the filter housing cover 5 is configured to enclose the filter housing 6.

The filter housing 6 is the main body of the filter assembly, and in this embodiment, it is a cylindrical or tubular housing that forms part of the device's water flow path. Its upstream end is connected to the terminal end of the suction assembly (i.e., the outlet end of the first inlet pipe 2 or the second inlet pipe 4), receiving wastewater from the aquarium. Its downstream end is connected to the inlet port of pump 8 via a first connecting pipe 7. The interior of the filter housing 6 provides a receiving space for installing the filter medium.

The filter housing cover 5 is a detachable component, and in this embodiment, it has a threaded or Snap-On structure configured to enclose an open end of the filter housing 6 (preferably the upstream end or an end facilitating operation). Its primary function is to seal the filter housing, ensuring that water flows only through the designated path via the filter and preventing wastewater leakage. Concurrently, its detachability allows a user to easily open the filter housing for removing, cleaning, or replacing the internal filter medium. The knurled texture on the cover helps a user hand-tighten or loosen.

The filter installation structure 24 is a component located inside the filter housing 6, and its specific form can be a sleeve, bracket, or grid structure. Its primary function is to precisely position and support the actual filter medium (not shown). It ensures that the filter medium is in its correct position within the filter housing, limiting the incoming water flow to pass through the filter medium and thereby achieving effective filtration, which prevents water flow from bypassing the filter medium and losing its filtration function. In some embodiments, the filter installation structure 24 also includes a flow-guiding structure to optimize the uniformity of water flow through the filter material.

The filter medium is a replaceable component. Its material can be a porous filter material with a specific porosity, and its filtration precision is selectable to meet varying filtration requirements by choosing filter media with different porosities. Such filter media may include but are not limited to, filter floss, bio-cotton, activated carbon, or combinations thereof. Its filtration precision can be selected according to different water quality conditions and cleaning objectives (e.g., removing only large particles or simultaneously adsorbing fine suspension and suspended odors).

Pump 8 is the core power source of the entire aquarium water filtration system. Its primary function is to generate the necessary pressure differential to drive water flow to complete the whole circulation or discharge process. Specifically, it generates negative pressure (suction) at the inlet port, overcoming flow resistance from the suction assembly, pipes, and filter medium to draw wastewater from the aquarium into the device. Concurrently, it generates positive pressure at the outlet port, which pushes processed (or unprocessed) water toward the control valve 14 and drives the water back to the aquarium or discharges it from the device, depending on the valve status. The performance of the pump (e.g., flow rate and delivery head) directly affects the device's suction capability and water circulation efficiency. Pump 8 is positioned between the filter assembly and the control valve 14 and is housed within chamber 19 inside the handle 11, which not only protects the pump but also contributes to the compact overall structure of the device. The pump 8 can, for example, be a miniature centrifugal pump or a diaphragm pump, but it is not limited to these types of pumps. Its design must meet the requirements of providing sufficient flow rate and pressure within a limited space. The inlet port of pump 8 is connected to the outlet port of the filter housing 6 via the first connecting pipe 7. This implies that water entering the pump has passed through (or at least flowed past) the filter assembly. The outlet port of pump 8 is connected to the first inlet port 22 of control valve 14 via the second connecting pipe 16, delivering pressurized water flow to control valve 14 for selection of the water flow path. Pump 8 is an electric component connected via wire 9 to the device's power adapter (the power adapter itself is not shown). In some embodiments, the pump 8 can also be battery-powered. Pump 8 is controlled by a control circuit located within the handle 11. Buttons 12 are on the handle 11. The buttons 12 are multiple, where one can be used to control the starting and stopping of the pump 8, and another can be used to control the pump's rotational speed, thereby controlling the entire device's operation. The button 12 for controlling rotational speed can be multiple, each corresponding to a preset rotational speed of the pump. The wire 9 is typically routed adequately within the handle 11 and waterproofed.

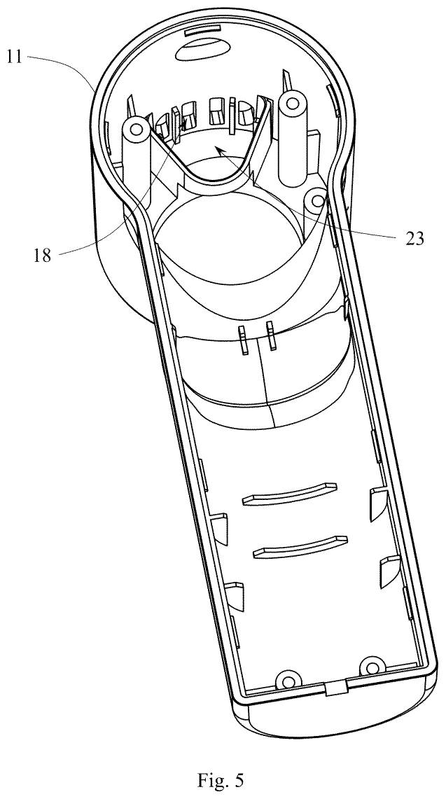

The control valve 14 is a crucial component of the aquarium water filtration device, enabling multi-functionality. It is configured to receive pressurized water flow from pump 8 and, based on a user's operational selection (via knob 15), precisely direct the water flow to one of two different outlet paths: either the backwater channel for returning to the aquarium or the drainage channel for discharging from the aquarium. As shown in FIGS. 2 and 5, the control valve 14 is installed within chamber 19 of handle 11, located downstream of pump 8. The control valve 14 includes a first inlet port 22, a first outlet port 21, and a second outlet port (not shown). The control valve 14 is preferably a rotary selector valve, which comprises a rotatable valve core (not shown) therein. The valve core is designed with specific blocking portions (not shown) that, when the valve core rotates to a particular position, block or completely close the passage of either the first outlet port 21 or the second outlet port on the valve body. An external knob 15 is connected to this valve core via a drive shaft (not shown). When a user rotates the knob 15, the valve core rotates accordingly. At different rotational angles, internal passages within the valve core selectively connect the first inlet port 22 with the first outlet port 21 (while simultaneously closing the second outlet port path) or connect the first inlet port 22 with the second outlet port (the path leading to the seal cap 13) (while simultaneously closing the first outlet port 21). This selective opening and closing action achieves the switching of water flow between the two outlet channels. The control valve body and valve core are typically made of corrosion-resistant plastic or metal and include necessary seals (such as O-rings) to ensure that water flow is effectively guided to the selected outlet at different switching positions and to prevent water leakage from non-selected outlets or valve seams under high pressure. The knob 15 or its surrounding area can be provided with markings (e.g., “RETURN” and “DRAIN”) to indicate the current mode status of the valve.

The backwater channel is configured to guide filtered water, which has passed through the filter housing and been pressurized by the pump, back into the aquarium during a filtered return mode. Its design aims to achieve internal water circulation and cleaning while ensuring a smooth return process, thereby preventing excessive disturbance to the aquarium environment. Referring to FIGS. 2 and 5, the backwater channel comprises an outlet channel 23 and a seal cap 13, with the origin of the backwater channel connected to the second outlet port of the control valve 14. When control valve 14 is switched to the backwater mode, pressurized filtered water enters the backwater channel from this outlet. When the device is in the filtered return mode, water flows sequentially through the second outlet port of the control valve 14, the seal cap 13, the outlet channel 23, and then gently returns to the aquarium water body via a plurality of drain holes 18 (diffusion structure).

The seal cap 13 plays a vital role in connection and guidance. As shown in FIGS. 2 and 5, it is installed inside the handle 11, tightly engaging the second outlet port of the control valve 14. Its primary function is to receive water flow from the valve and reliably, without leakage, direct it into the internal outlet channel 23 of the handle. Its ‘sealing’ characteristic ensures that the water flow is fully contained within the predetermined path while also serving to fix or position related components of the control valve.

Outlet Channel 23 is the main body of the backwater channel. As shown in FIG. 3, outlet channel 23 is an internal water channel integrally formed directly within the plastic housing of the handle 11. In some embodiments, the outlet channel 23 can also be embedded within the plastic housing; in some embodiments, the outlet channel 23 can also be a pipe structure. The seal cap 13 latches onto the downstream extension of the outlet channel 23 and guides the water flow to the device's backwater port (drain hole 18). Its shape and dimensions are designed to convey water flow smoothly.

The drain holes 18/backwater port serve as the final outlet of the backwater channel, directly facing the aquarium water body. As shown in FIG. 5, the drain holes 18 are located downstream of the outlet channel 23. Multiple drain holes 18 form a diffusion structure. By providing multiple small holes instead of a single large opening, the returning water can be dispersed, creating a softer, more uniform water flow back into the aquarium. This helps reduce the scouring of the substrate, avoids startling fish, and distributes the clean water more broadly throughout the water body. In some embodiments, the number of drain holes can also be one.

The drainage channel is configured to discharge water from the aquarium (which, depending on the filter medium's condition, may be filtered, partially filtered, or unfiltered water if the filter medium is removed for improved drainage efficiency) from the device to a designated external location (e.g., a bucket or drain), allowing a user to conveniently change part or all of the aquarium water while cleaning the substrate. Referring to FIGS. 2 and 5, the drainage channel includes a third connecting pipe 17 and a drain end 10. The drainage channel originates at the control valve and terminates at a designated external location of the device. When the device is switched to the drainage/water exchange mode and the pump is activated, water flows sequentially through pump 8, the second connecting pipe 16, the control valve 14, the first inlet port 22, the internal switching passage of the control valve, the first outlet port 21 of the control valve, the third connecting pipe 17, the drain end 10, and a user-connected external drainage hose, then discharges to the designated external location outside the aquarium. A user can complete the drainage operation by placing the other end of the hose into a collection container or directing it directly to a drainage system.

The handle 11 is a significant structural component and user interface of the aquarium water filtration device, not only providing a convenient and comfortable gripping portion that allows a user to operate and move easily but also serving as an integration platform for core components, consolidating the device's power, control, and portions of its fluid pathways. As shown in FIG. 1, the handle 11 forms the main body of the rear portion of the device. Its external shape is typically ergonomically designed to conform to a user's hand grip, ensuring stability and comfort during operation in submerged or wet environments. Referring to FIGS. 2 and 3, the handle is internally designed with one or more chambers 19. This space is configured to securely and stably install and protect critical components, preventing them from external impact or direct water ingress (for non-submersible components). Major components housed within the chamber include the pump 8, the control valve 14, portions of the water flow pipes connecting these components (e.g., the second connecting pipe 16, the third connecting pipe 17, etc.), the seal cap 13, and the wire 9 for powering and controlling the pump. The internal structure of the chamber (e.g., reinforcing ribs, positioning posts, etc., as shown in FIG. 5) helps to fix these components precisely. The outer surface of handle 11 serves as the mounting location for user control elements. Button 12 can serve as a power switch, a start/stop button, or an adjustment button, placed in an easily accessible position for a finger (typically the thumb) to control the start and stop of pump 8. The knob 15 is also mounted externally on the handle. It is directly connected to the valve core of the control valve 14 via an internal mechanical linkage structure (not shown). A user can conveniently switch the device's operating mode (filtered backwater or drainage) by rotating this knob. The handle 11 is not merely a housing for components; it also participates in forming part of the water flow path itself. As shown in FIG. 3, outlet channel 23 for the backwater mode is an integral channel formed directly within the internal structure of the handle. Water flows through the seal cap 13, then enters this integrated outlet channel, and finally exits from the drain hole 18 at the end of the handle. Additionally, the handle provides a mounting base for the drain end 10, securely integrating the outlet of the drainage channel into the main body of the device. Handle 11 is typically manufactured from robust, water-resistant engineering plastics (e.g., ABS, PP) using an injection molding process. To facilitate installation and maintenance of internal components, it is often designed as a separable two-half structure (as shown in the exploded view of FIG. 2), assembled using screws, snaps, or other fasteners to form an enclosed unit. The handle 11 ingeniously integrates gripping, housing, control, and partial fluid conveying functions, achieving a compact arrangement, integration, and user-friendly operation of the device.

The aforementioned aquarium water filtration device integrates debris suction, water filtration, and water exchange functions. A user can conveniently switch between different operating modes simply by operating the control valve, eliminating the need for frequent equipment changes or complex operations. The detachable suction assembly and filter housing design facilitate easy assembly, disassembly, and maintenance according to user needs. The rotary selector valve provides simple and reliable operation. The diffusion structure at the bottom of the outlet channel enables the returned water to be evenly distributed back into the aquarium, reducing the impact on the aquarium's ecological environment. Its compact structure and convenient and highly efficient operation significantly enhance the efficiency and convenience of aquarium maintenance.

### Glossary of Professional Terms

Aquarium Water Filtration Device: The comprehensive apparatus disclosed, constituting a integrated system designed to perform multiple critical aquarium maintenance functions, including the removal of bottom debris, purification of waterborne impurities through filtration, and facilitating partial or complete water changes, all within a single, efficient unit.

Suction Assembly: A functional sub-system of the device specifically engineered to draw wastewater, which contains accumulated particulate matter such as fish food residue, excrement, and substrate debris, directly from the aquatic environment of the aquarium. It typically includes specialized intake ports and conduits designed for effective collection of impurities.

Filter Assembly: A dedicated sub-system, positioned in direct fluid communication with the suction assembly, configured to physically intercept, trap, and remove solid impurities from the drawn wastewater. This assembly commonly comprises a filter housing, a detachable cover, and an internal structure designed to securely hold a replaceable filter medium, ensuring water purification.

Pump (e.g., Pump 8): The core electro-mechanical component serving as the device's power source for fluid movement. It generates the necessary pressure differential—creating negative pressure (suction) at its inlet to draw water in and positive pressure at its outlet—to drive the water flow throughout the entire system, enabling both circulation and discharge processes.

Control Valve (e.g., Control Valve 14): A crucial multi-functional component, typically implemented as a rotary selector valve, that receives pressurized water flow from the pump. Its primary function is to precisely direct this water flow to one of two distinct fluid pathways (either the backwater channel or the drainage channel) based on a user's manual selection, thereby enabling the switching between different operational modes.

Backwater Channel: A designated internal fluid pathway within the device specifically configured to guide filtered water—water that has successfully passed through the filter assembly and subsequently been pressurized by the pump—gently and uniformly back into the aquarium. This channel facilitates internal water circulation and continuous purification without external discharge.

Drainage Channel: A dedicated fluid pathway within the device specifically configured to discharge wastewater from the aquarium to a predetermined external collection point, such as a bucket or a direct drain. This channel is essential for facilitating partial or complete water changes, often performed concurrently with substrate cleaning.

In Fluid Communication: A fundamental technical relationship indicating that two or more distinct components, sub-systems, or assemblies within a hydraulic or pneumatic system are interconnected in a manner that allows for the controlled or continuous flow of liquid (or gas) between them. This connection establishes a direct pathway for fluid transfer, enabling the sequential operation of the device's various stages.

Filter Medium: A replaceable, porous material (e.g., filter floss, bio-cotton, activated carbon, or combinations thereof) that is selectively installed within the filter housing of the filter assembly. Its primary function is to physically intercept, adsorb, or otherwise remove solid impurities and dissolved contaminants from the water based on its specific material properties and porosity.

Filtration Precision: A critical performance characteristic of a filter medium, which quantifies its effectiveness in removing particulate matter and impurities of specific sizes from the water. It is primarily determined by the filter material's pore size distribution and structure, allowing for selection based on varying water quality conditions and cleaning objectives.

Rotary Selector Valve: A specific type of control valve that utilizes a rotatable internal valve core. By manually rotating this core to different predetermined positions, it selectively opens or completely closes specific internal fluid passages, thereby redirecting the flow of water from a common inlet to one of multiple distinct outlet ports or channels.

Valve Core: The internal, rotatable component housed within a rotary selector valve (e.g., control valve 14). It is precisely designed with specific blocking portions or internal channels that, when rotated to various angular positions, establish or interrupt fluid connections between the valve's inlet and its various outlet ports, thereby controlling the flow path.

Pressure Differential: The fundamental driving force for fluid movement within a confined system, representing the difference in fluid pressure between two distinct points (e.g., inlet and outlet of a pump). The pump in the device generates this differential to overcome flow resistance and propel water through the filtration and circulation pathways.

Flow Resistance: The collective impedance or opposition encountered by the water flow as it moves through the internal components and channels of the device. This resistance arises from factors such as friction within pipes, the tortuosity of filter media, and changes in flow direction, requiring the pump to exert sufficient pressure to overcome it.

Diffusion Structure: A design feature, typically comprising a plurality of small drain holes (e.g., drain holes 18) at the outlet end of the backwater channel. Its purpose is to evenly and gently disperse the returning filtered water back into the aquarium, creating a soft, uniform flow that minimizes disturbance to the substrate and avoids startling aquatic inhabitants.

Detachable Components: Elements of the device (e.g., suction ports, inlet pipes, filter housing cover) that are specifically designed to be easily separated from and reconnected to the main assembly, typically without requiring specialized tools. This design principle enhances user convenience for assembly, disassembly, cleaning, maintenance, and part replacement.

Modular Design: An engineering approach applied to the device's construction, particularly the suction assembly, where interchangeable components (e.g., first inlet pipe 2, adapter 3, second inlet pipe 4) can be combined or swapped. This allows users to flexibly adjust the device's physical configuration (e.g., overall length) to suit varying aquarium depths or specific operational requirements.

Ergonomically Designed: Pertains to the thoughtful shaping and configuration of the device's handle (e.g., handle 11) to conform comfortably and naturally to a user's hand grip. This design principle aims to ensure stability, reduce user fatigue, and provide a secure and comfortable hold during operation, particularly in submerged or wet conditions.

Water Exchange Mode: An operational state of the device, selected via the control valve, where the primary objective is to facilitate the partial or complete replacement of the aquarium water. In this mode, water is drawn from the aquarium, processed through the filter (or bypasses it), and then actively discharged out of the tank via the drainage channel to an external collection point.

Filtered Return Mode (Backwater Mode): An operational state of the device, selected via the control valve, where the primary objective is internal water circulation and continuous filtration without external discharge. In this mode, water is drawn from the aquarium, thoroughly purified by the filter assembly, and then immediately guided back into the aquarium via the backwater channel.

Chamber (e.g., Chamber 19): An internal, enclosed compartment or space within the device's housing (e.g., handle 11) specifically configured to securely and stably house, protect, and often precisely position critical internal components such as the pump, control valve, and associated electrical wiring or fluid conduits, shielding them from external impacts or direct water ingress.

Substrate: The material forming the bottom layer of an aquarium, which can consist of various materials such as gravel, sand, or a bare tank bottom. This layer often accumulates particulate waste, and the device's suction assembly is designed for effective cleaning of this area.

Impeller: A rotating component within a centrifugal pump (e.g., pump 8) that is equipped with vanes or blades. As it spins at high speed, it imparts kinetic energy to the fluid (water), drawing it in at the center and propelling it outwards by centrifugal force, thereby creating the necessary pressure and flow for the pump's operation.

Fluid Pathways: The collective network of internal channels, pipes, conduits, and compartments within the device through which water flows sequentially during its various operational modes. These pathways are strategically designed to guide, direct, contain, and control the movement of fluid from the point of intake through all processing stages to the final discharge or return.

The embodiments described above are merely examples of the present disclosure, and should not be used to limit the scope of the present disclosure, which may have various modifications and variations made by specialists in the field. Any modification, equivalent replacement or improvement made within the spirits and principles of the present disclosure shall be included in the scope of protection of the present disclosure.

What is claimed is:

1. An aquarium water filtration device, comprising:
a suction assembly configured to draw wastewater from an aquarium;
a filter assembly, in fluid communication with the suction assembly, is configured to filter the wastewater;
a pump, in fluid communication with the filter assembly, is configured to drive a water flow;
a control valve having a first inlet port, a first outlet port, and a second outlet port, wherein the first inlet port is in fluid communication with the pump;
a backwater channel, in fluid communication with the second outlet port, is configured to guide filtered water back to the aquarium; and
a drainage channel, in fluid communication with the first outlet port, is configured to discharge the wastewater out of the aquarium;
wherein the control valve is configured to selectively switch the flow state of the first outlet port and the flow state of the second outlet port to selectively guide the water to the backwater channel or the drainage channel.

2. The aquarium water filtration device of claim 1, wherein the filter assembly comprises a detachable filter housing, and a replaceable filter medium is inside the filter housing.

3. The aquarium water filtration device of claim 2, wherein the filter medium is made of porous filter material, and the filter media, having different porosities, are changeable to meet varying filtration requirements.

4. The aquarium water filtration device of claim 1, wherein the control valve is a rotary selector valve operable via a manual knob to switch the flow state of the first outlet port and the second outlet port.

5. The aquarium water filtration device of claim 4, wherein the rotary selector valve comprises a rotatable valve core configured to selectively block the first outlet port or the second outlet port when rotated to different positions, thereby switching the flow state.

6. The aquarium water filtration device of claim 1, wherein the suction assembly comprises a first suction port and a first inlet pipe disposed between the first suction port and the filter housing, one end of the first inlet pipe is detachably connected to the first suction port, and another end of the first inlet pipe is detachably connected to the filter housing, the first inlet pipe is in fluid communication with the first suction port and the filter housing to enable sequential water flow from the first suction port, through the first inlet pipe, and into the filter housing.

7. The aquarium water filtration device of claim 6, wherein the suction assembly further comprises a second inlet pipe and an adapter, one end of the second inlet pipe is detachably connected to the first inlet pipe via the adapter, and another end of the second inlet pipe is detachably connected to the filter housing, the second inlet pipe is in fluid communication with the first inlet pipe and the filter housing to enable sequential water flow from the first suction port, through the first inlet pipe, the adapter, the second inlet pipe, and into the filter housing.

8. The aquarium water filtration device of claim 1, wherein the backwater channel comprises an outlet channel and a seal cap, and the seal cap, which seals the outlet channel, is in fluid communication with both the second outlet port of the control valve and the outlet channel to guide the water flow from the control valve into the outlet channel.

9. The aquarium water filtration device of claim 8, wherein an outlet end of the outlet channel is provided with a diffusion structure to distribute the backflow water back into the aquarium uniformly.

10. The aquarium water filtration device of claim 9, wherein the diffusion structure is a plurality of drain holes, and the drain holes are configured to guide the water flow back into the aquarium uniformly.
